(19) United States
(12) Patent Application Publication
(10) Pub. No.: US 2026/0247026 A1
(43) Pub. Date: Aug. 20, 2026

(54) ELECTRONIC DEVICE AND FOCUSING METHOD FOR PHOTOGRAPHY THEREOF

(71) Applicant: ASUS GLOBAL PTE. LTD., Singapore (SG)

(72) Inventor: Yongbo Jiang, Singapore (SG)

(73) Assignee: ASUS GLOBAL PTE. LTD., Singapore (SG)

(21) Appl. No.: 19/529,126

(22) Filed: Feb. 4, 2026

(30) Foreign Application Priority Data
Feb. 14, 2025 (TW) 114105536

(51) Int. Cl. H04N 23/63; H04N 23/62; H04N 23/67; H04N 23/68

(52) U.S. Cl. CPC H04N 23/632; H04N 23/62; H04N 23/635; H04N 23/675; H04N 23/68

(57) ABSTRACT

An electronic device and a focusing method for photography thereof are provided. The method is adapted to the electronic device including a touch screen and a camera module and includes the following steps. A focus command performed on a camera preview screen is received via the touch screen. Based on the focus command, a focusing process is executed, and a countdown is initiated according to a delay time. During the countdown, whether a user operation command is received via the touch screen is determined. If no user operation command is received during the countdown, the camera module is controlled to photograph a target photo based on a focus parameter of the focusing process upon completion of the countdown.

### CROSS-REFERENCE TO RELATED APPLICATION

This application claims the priority benefit of Taiwan application serial no. 114105536, filed on February 14, 2025. The entirety of the above-mentioned patent application is hereby incorporated by reference herein and made a part of this specification.

### BACKGROUND

### Technical Field

The disclosure relates to a focusing method for photography and an electronic device using this method.

### Related Art

With the advancement of technology, the camera function has become one of the basic functions of mobile phones. In existing mobile phone capture technology, users typically need to perform two consecutive operations to complete each shooting. First, the user needs to tap a specific area on the screen to focus, and then tap the shutter button or another key to capture the image. However, this operational method has certain issues, primarily in the following two aspects. First, the additional tap after completing the focus process can easily cause hand tremors, reducing the clarity of the captured image. Second, manually tapping the shutter button introduces a delay in capturing the image, which may prevent the user from capturing critical moments due to the lag. Traditional technologies allow users to trigger the shutter by tapping anywhere on the screen or using voice commands, but they still fail to fundamentally resolve the issue of hand tremors. Additionally, while burst mode increases the likelihood of capturing the desired shot, it still requires manual operation, which affects real-time responsiveness.

### SUMMARY

The disclosure provides a focusing method for photography, which is adapted to an electronic device including a touch screen and a camera module, the method includes the following steps. A focus command performed on a camera preview screen is received via the touch screen. Based on the focus command, a focusing process is executed, and a countdown is initiated according to a delay time. During the countdown, whether a user operation command is received via the touch screen is determined. If no user operation command is received during the countdown, the camera module is controlled to photograph a target photo based on a focus parameter of the focusing process upon completion of the countdown.

The disclosure also provides an electronic device, which includes a touch screen, a camera module and a processor. The processor is coupled to the camera module and the touch screen. The processor is configured to execute the following operations. A focus command performed on a camera preview screen is received via the touch screen. Based on the focus command, a focusing process is executed, and a countdown is initiated according to a delay time. During the countdown, whether a user operation command is received via the touch screen is determined. If no user operation command is received during the countdown, the camera module is controlled to photograph a target photo based on a focus parameter of the focusing process upon completion of the countdown.

Based on the above, in the disclosure, a focus command is received via the touch screen to trigger the execution of the focus process and trigger the countdown. If no user operation command is received via the touch screen before the countdown ends, the camera module is automatically controlled to capture the target photo according to the focus parameter. Based on this, the shaking problem caused by touching the screen at the moment of photo capturing is effectively reduced. In addition, the focusing and capturing process is achieved through simple operations, thereby increasing the image capture efficiency and enhancing the user experience.

### BRIEF DESCRIPTION OF THE DRAWINGS

FIG. 1 is a block diagram of an electronic device illustrated according to an embodiment of the disclosure.

FIG. 2 is a flowchart of a focusing method for photography illustrated according to an embodiment of the disclosure.

FIG. 3A and FIG. 3B are schematic diagrams of preview screens illustrated according to an embodiment of the disclosure.

FIG. 4 is a flowchart of a preview image illustrated according to an embodiment of the disclosure.

FIG. 5 is a flowchart of a preview image illustrated according to an embodiment of the disclosure.

FIG. 6 is a schematic diagram of extraction time of target image and reference image illustrated according to an embodiment of the disclosure.

### DESCRIPTION OF THE EMBODIMENTS

Reference will now be made in detail to exemplary embodiments of the disclosure, examples of which are illustrated in the accompanying drawings. Wherever possible, the same reference symbols are used in the drawings and descriptions to refer to the same or similar parts. These embodiments are only a part of the disclosure and do not reveal all possible embodiments of the disclosure. More precisely, these embodiments are only examples of devices and methods within the scope of the patent application of the disclosure.

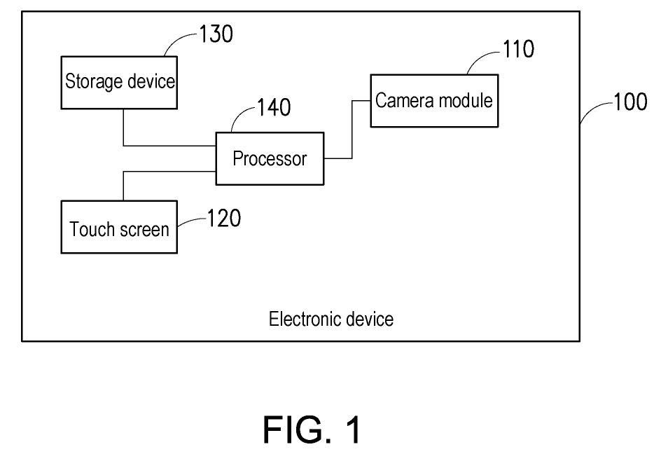

Referring to FIG. 1, the electronic device 100 may include a camera module 110, a touch screen 120, a storage device 130, and a processor 140. In some embodiment, the electronic device 100 is a smartphone, a digital camera, a tablet computer, a game console, an electronic wearable device, or a photographic device, or various electronic devices with image capture function, and the type of the electronic device 100 is not limited.

The camera module 110 is configured to capture images, which may include a lens, an image sensor, and other components. The lens may include optical lenses, which are used for light path control. The image sensor is configured to provide image sensing function. The image sensing component of the image sensor may include photosensitive components, such as Charge Coupled Device (CCD), Complementary Metal-Oxide Semiconductor (CMOS) components or other components, which are not limited by the disclosure. The lens may converge imaging light on the image sensor to achieve the purpose of extracting images.

The touch screen 120 is a display device that integrates touch detection components, which can provide both display and input functions simultaneously. This display device is, in an embodiment, a liquid crystal display (LCD), a light-emitting diode (LED) display, a field emission display (FED), or other types of displays, but is not limited herein. The touch detection components are arranged in rows and columns on the display device to detect the touch of the user's finger, palm, or other objects appear on the touch screen 20. The touch detection components are, in an embodiment, capacitive touch detection components, surface acoustic wave touch detection components, electromagnetic touch detection components, or near field imaging touch detection components, but are not limited to these.

The storage device 130 is configured to store files, images, commands, program codes, software modules, and other data, which is, in an embodiment, any type of fixed or removable random access memory (RAM), read-only memory (ROM), flash memory, hard disk or other similar devices, integrated circuits or combinations thereof.

The processor 140 is coupled to the camera module 110, the touch screen 120, and the storage device 130, which is, in an embodiment, a central processing unit (CPU), an application processor (AP), or other programmable general-purpose or special-purpose microprocessor, digital signal processor (DSP), image signal processor (ISP), graphics processing unit (GPU) or other similar devices, integrated circuits or combinations thereof. In some embodiments, the processor 140 executes instructions or program codes in the storage device 130 to implement various steps of the focusing method for photography in the embodiments of the disclosure.

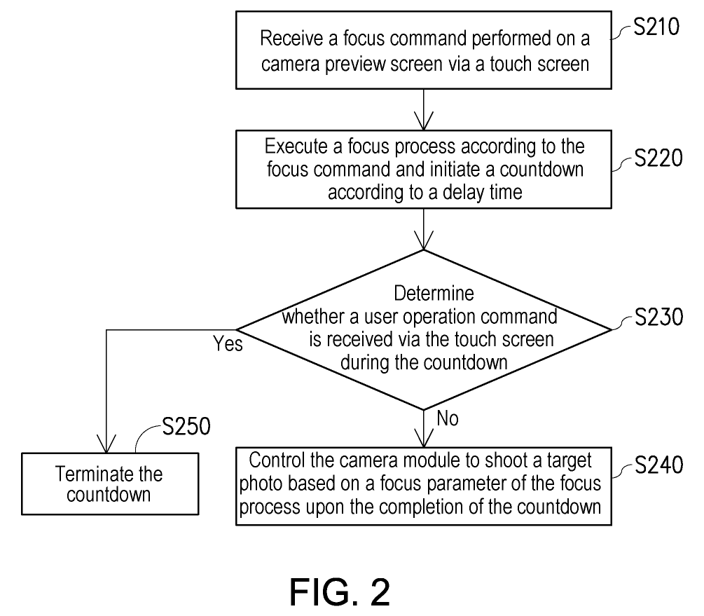

FIG. 2 is a flowchart illustrating a focusing method for photography according to an embodiment of the disclosure. Referring to FIG. 2, the method of this embodiment is executed by the electronic device 100 of FIG. 1, and the details of each step in FIG. 2 will be explained in conjunction with the components shown in FIG. 1.

At step S210, the processor 140 receives a focus command performed on a camera preview screen via the touch screen 120. Specifically, when the processor 140 executes the camera function, the processor 140 controls the touch screen 120 to display the camera preview screen. The processor 140 detects a touch operation performed on the camera preview screen through the touch screen 120 to obtain the focus command. The touch position of the focus command is configured to specify the target focus area, thereby guiding the processor 140 to initiate the subsequent focus process, ensuring accurate focus operations on the target area.

At step S220, the processor 140 executes the focus process according to the focus command and initiates a countdown according to a delay time. Specifically, in response to the processor 140 receives the focus command performed on the camera preview screen via the touch screen 120, the processor 140 executes the focus process. The processor 140 determines the focus area based on the touch position of the focus command in the camera preview screen. Furthermore, when the user performs a touch operation, such as clicking, pressing, etc., on the camera preview screen, the processor 140 detects the touch position of this touch operation, and sets a focus area with a predetermined size centered on the touch position. Afterwards, the processor 140 executes the focus process according to the focus area. The focus process includes adjusting the position of the lens in the camera module 110 to perform optical focusing based on the focus area selected by the user. In an embodiment, the processor 40 uses focusing techniques such as hill climbing to control the lens to move to the focus position, thereby captures image content with maximum sharpness in the focus area. Alternatively, the focus process includes driving the image processing unit (ISP) to enhance the image sharpness within the focus area.

In some embodiments, when the focus process is completed, the processor 140 initiates a countdown according to the delay time. Specifically, after completing the focus process, the processor 140 initiates a countdown according to a delay time. In various embodiments, the setting of the delay time is determined according to user needs or scene content to meet the shooting requirements of different scenes. In an embodiment, the delay time is 2 seconds, 5 seconds, or other time lengths, which is not limited herein. Additionally, in one embodiment, the delay time may also be 0 seconds. . The processor 140 may respond to the completion of the focus process by starting a delay timer to count down from the seconds corresponding to the delay time.

At step S230, during the countdown, the processor 140 determines whether a user operation command is received via the touch screen 120. Specifically, during the countdown duration, the processor 140 determines whether the touch screen 120 has received any touch operation issued by the user.

In some embodiments, the user operation command is another focus command performed on the camera preview screen. In some embodiments, the user operation command is a shooting-related command applied to the camera application interface, which includes the camera preview screen. Such commands include a zoom command for capturing photos, a brightness adjustment command, a flash setting command, or other shooting configuration commands.

At step S240, if no user operation command is received during the countdown (step S230 is determined to be negative), the processor 140 controls the camera module 110 to shoot a target photo based on a focus parameter (such as the focus position of the lens) of the focus process upon the completion of the countdown. That is, during the countdown, the processor 140 detects user operation commands on the touch screen 120. If no user operation command is received during the countdown duration, it means the user is already satisfied with the settings of various photo parameters, the overall composition, and the focus result, therefore the processor 140 continues the countdown. In response to that the processor 140 counts down from the seconds corresponding to the delay time to zero, the processor 140 triggers the camera module 110 to capture the target photo.

In some embodiments, the processor 140 sets the delay time according to a user setting command. In detail, the processor 140 provides an operation interface for setting the delay time via the touch screen 120, which includes intuitive interactive UI components such as sliders, numeric input boxes, or preset option buttons. The user adjusts or specifies the desired delay time value by performing operations such as sliding, tapping, or inputting via the touch screen 120.

In some embodiments, the processor 140 sets the delay time according to the scene content. Furthermore, the processor 140 identifies the shooting scene as a static scene or a dynamic scene according to the preview image. When the shooting scene is a static scene, the processor 140 sets the delay time to a first-time length. When the shooting scene is a dynamic scene, the processor 140 sets the delay time to a second time length. The first time length is greater than the second time length. Therefore, in a static scene, the user prepares adequately according to the longer delay time, while in a dynamic scene, the user chooses a 0-seconds delay to increase the shooting speed, thereby enhancing the overall user experience and shooting efficiency.

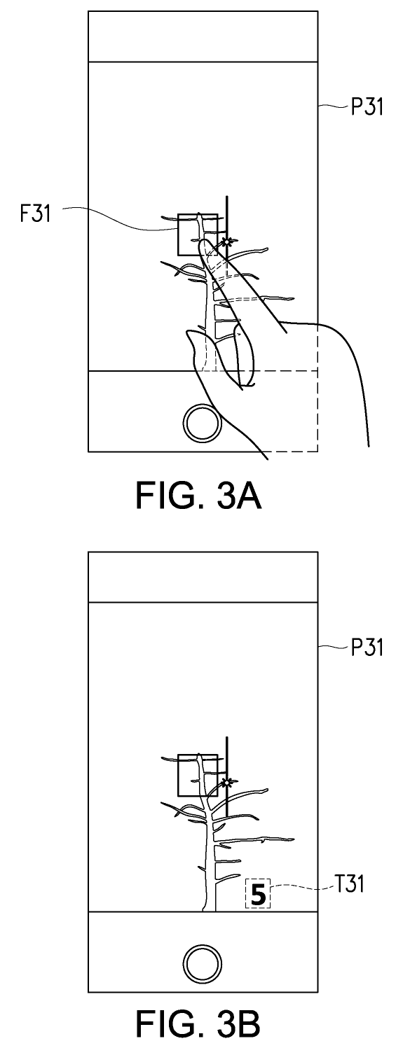

In an embodiment, referring to FIG. 3A, which is a schematic diagram of a camera preview screen illustrated according to an implementation of the disclosure. The touch screen 120 displays a camera preview screen P31. When the user's finger taps on the camera preview screen P31, the processor 140 identifies this tapping operation as a focus command and determines the focus area F31 according to the touch position of this tapping operation. Thus, the processor 140 performs the focus process according to the focus area F31. Afterwards, FIG. 3B, which illustrates a schematic diagram of a camera preview screen according to an implementation of the disclosure, is referring to. When the processor 140 receives a focus command performed on the camera preview screen P31 via the touch screen 120 or completes the focus process, the processor 140 initiates a countdown according to the delay time, and displays the duration of the countdown on the camera preview screen P31. As shown in FIG. 3B, the duration T31 of the countdown is displayed on the shooting preview screen P31.

On the other hand, at step S250, if a user operation command is received during the duration (step S230 is determined to be yes), the processor 140 terminates the countdown. In detail, when the processor 140 receives a user operation command during the countdown duration, it means that the user is not yet satisfied with the photo parameter settings, overall composition, or focus results, therefore the processor 140 terminates the countdown. At the same time, the processor 140 executes the operation corresponding to the user operation command. In an embodiment, the processor 140 adjusts the zoom ratio of the camera module 110 according to the photo zoom command. Alternatively, the processor 140 adjusts various photo parameters according to other shooting setting commands, such as exposure compensation commands, filter setting commands, or flash setting commands.

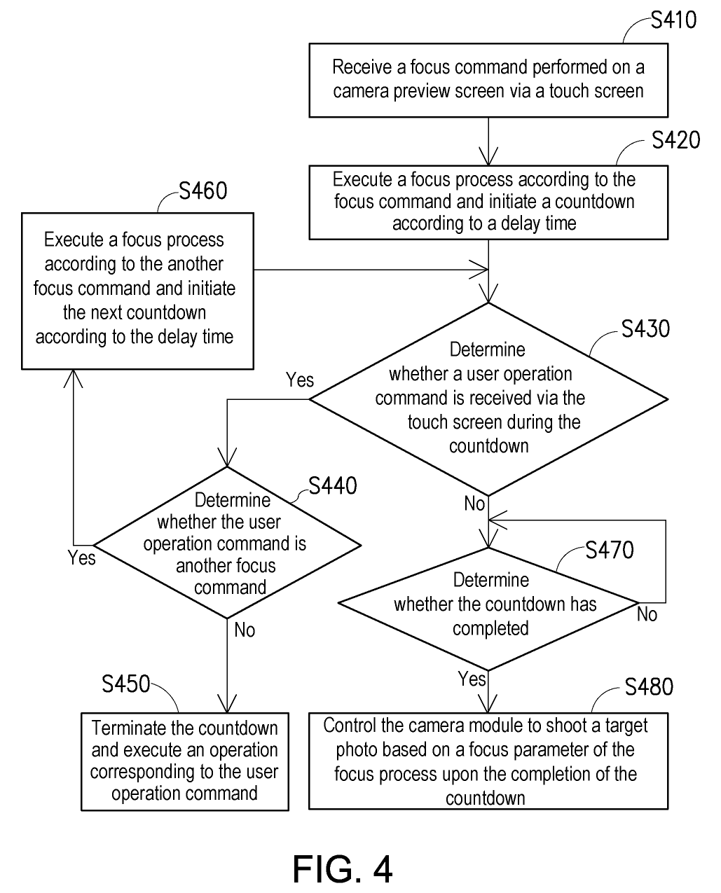

FIG. 4 is a flowchart of a focusing method for photography illustrated according to an implementation of the disclosure. Referring to FIG. 4, the method of this implementation is executed by the electronic device 100 of FIG. 1. The details of each step in FIG. 4 will be explained below in conjunction with the components shown in FIG. 1.

At step S410, the processor 140 receives a focus command performed on the camera preview screen via the touch screen 120. At step S420, the processor 140 executes the focus process according to the focus command and initiates a countdown according to a delay time. At step S430, during the countdown, the processor 140 determines whether a user operation command is received via the touch screen 120. The implementation methods of steps S410 to S430 may refer to the previously described embodiments and will not be repeated here.

At step S440, when a user operation command is received via the touch screen 120 during the countdown (step S430 is determined to be yes), the processor 140 determines whether the user operation command is another focus command. That is, when a touch operation is received during the countdown duration, the processor 140 determines whether this touch operation is a focus command or other shooting setting command.

At step S450, if the user operation command is not another focus command (step S440 is determined to be no), the processor 140 terminates the countdown and executes the operation corresponding to the user operation command. At step S460, when another focus command is received via the touch screen 120 during the countdown (step S440 is determined to be yes), then the processor 140 initiates the next countdown according to the delay time, and back to step S430 That is, when the user issues another focus command during the countdown duration, the processor 140 executes the focus process again and re-execute the countdown.

At step S470, when no user operation command is received during the countdown duration (step S430 is determined to be no), the processor 140 determines whether the countdown has completed. At step S480, when no user operation command is received during the countdown duration and the countdown has completed (step S470 is determined to be yes), the processor 140 responds to the completion of the countdown by controlling the camera module 110 to shoot a target photo based on the focus parameter of the focus process.

In this way, the processor 140 responds to receiving a user operation command during the countdown duration by terminating the countdown, thereby avoiding capturing photos that the user does not want. Furthermore, according to the type of user operation command received during the countdown duration, the processor 140 re-executes the next countdown or execute other corresponding operations.

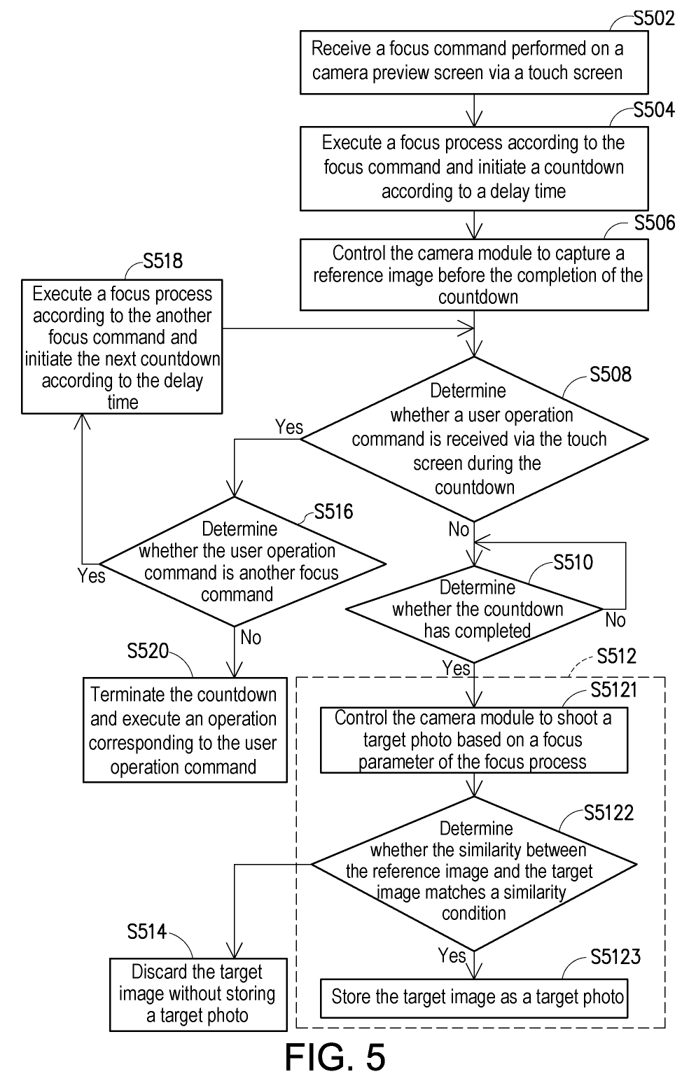

FIG. 5 is a flowchart of a focusing method for photography illustrated according to an implementation of the disclosure. Referring to FIG. 5, the method of this implementation is executed by the electronic device 100 of FIG. 1. The details of each step in FIG. 5 will be explained below in conjunction with the components shown in FIG. 1.

At step S502, the processor 140 receives a focus command performed on the camera preview screen via the touch screen 120. At step S504, the processor 140 executes the focus process according to the focus command and initiate a countdown according to a delay time. The implementation details of steps S502 to S504 refers to the previously described embodiments and will not be repeated here.

It should be noted that, at step S506, the processor 140 controls the camera module 110 to capture a reference image before the completion of the countdown. In some embodiments, the reference image is captured in response to the completion of the focus process.

At step S508, the processor 140 determines whether a user operation command is received via the touch screen 120 during the countdown.

At step S510, when no user operation command is received during the countdown duration (step S508 is determined to be no), the processor 140 determines whether the countdown has completed. At step S512, when no user operation command is received during the countdown and the countdown has completed (step S510 is determined to be yes), the processor 140 responds to the completion of the countdown by controlling the camera module 110 to shoot a target photo based on the focus parameters of the focus process. In this embodiment, step S512 is implemented as steps S5121 to S5123.

At step S5121, the processor 140 responds to the completion of the countdown by controlling the camera module 110 to extract a target image based on the focus parameters of the focus process. Specifically, the processor 140 uses the target focus area and related focus parameters determined in the focus process to drive the camera module 110 to capture the target image.

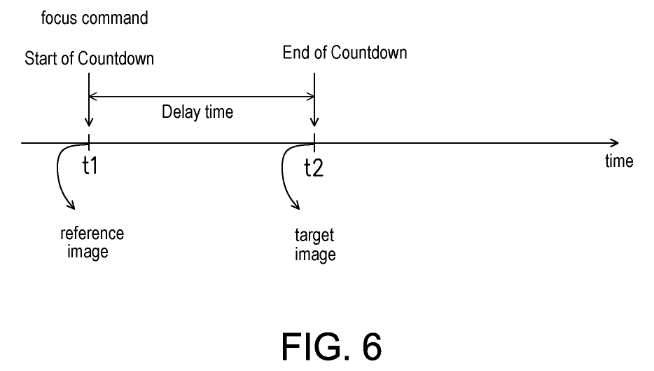

Referring to FIG. 6, which is a schematic diagram illustrating the extraction time of the target image and reference image according to an implementation of the disclosure. In some embodiments, the processor 140 completes the focus process at time point t1 and execute the countdown, and control the camera module 110 to capture the reference image when the focus process is completed at time point t1. Afterwards, when the countdown has completed, that is, after the delay time has elapsed, the processor 140 controls the camera module 110 to capture the target image.

At step S5122, the processor 140 determines whether the similarity between the reference image and the target image matches the similarity condition. Specifically, by using Structural Similarity Index Measure (SSIM), feature point matching algorithms (such as SIFT or ORB), or other statistical models, the processor 140 compares the degree of similarity between the texture, color, and geometric features of the reference image and the target image. The processor 140 obtains the similarity between the reference image and the target image according to an image similarity evaluation algorithm. The processor 140 determines whether the similarity is higher than a preset threshold. When the similarity is higher than the preset threshold, the processor 140 determines that the similarity between the reference image and the target image matches the similarity condition. Otherwise, when the similarity is not higher than the preset threshold, the processor 140 determines that the similarity between the reference image and the target image does not match the similarity condition.

At step S5123, when the similarity between the reference image and the target image matches the similarity condition, the processor 140 stores the target image as the target photo. When the similarity between the reference image and the target image matches the similarity condition, it means that the user maintains the shooting scene during the countdown duration, therefore the target image matches the user's initial shooting intention. As a result, the processor 140 generates a target photo including metadata based on the target image, and record this target photo to the storage device 130. The above-mentioned metadata includes, in an embodiment, shooting time, location, and shooting parameters, to facilitate subsequent retrieval and management by the user.

At step S514, when the similarity between the reference image and the target image does not match the similarity condition, the processor 140 discards the target image without storing the target photo. Specifically, when the similarity between the reference image and the target image does not match the similarity condition, it means that the user significantly changes the shooting scene during the countdown duration, such as readjusting the composition, moving the device position, or changing the shooting subject. Therefore, the target image can no longer match the user's initial shooting intention. Based on this judgment, the processor 140 discards the target image to avoid storing photos that do not meet the user's needs.

In addition, at step S516, when a user operation command is received through the touch screen 120 during the countdown (step S508 is determined to be yes), the processor 140 determines whether the user operation command is another focus command. At step S520, when the user operation command is not another focus command (step S516 is determined to be no), the processor 140 terminates the countdown and execute the operation corresponding to the user operation command. At step S518, when another focus command is received through the touch screen 120 during the countdown (step S516 is determined to be yes), then the processor 140 initiates the next countdown according to the delay time, and back to step S508. The implementation of steps S516 to S520 may refer to the aforementioned embodiments, which will not be repeated here.

In summary, in the embodiments of the disclosure, a focus command may be received through the touch screen to trigger the execution of the focus process and initiate the countdown. When no user operation command is received via the touch screen before the countdown ends, the camera module is automatically controlled to capture the target photo according to the focus parameters. Based on this, the shaking problem caused by clicking operations at the moment of photo capture is effectively reduced. In addition, users may complete focusing and photo capturing through simple operations, thereby increasing the efficiency of photo capturing and enhancing user experience. Furthermore, through the flexible setting of delay time, more flexible shooting applications are realized to meet the needs of diverse scenes.

Although the disclosure has been described with embodiments as above, it is not intended to limit the disclosure. Any person with ordinary knowledge in the relevant technical field may make some modifications and refinements without departing from the spirit and scope of the disclosure. Therefore, the scope of protection of the disclosure should be defined by the appended claims.

What is claimed is:

1. A focusing method for photography, adapted to an electronic device comprising a camera module and a touch screen, the method comprising:
receiving a focus command performed on a camera preview screen via the touch screen;
executing a focus process according to the focus command and initiating a countdown according to a delay time;
determining whether a user operation command is received via the touch screen during the countdown; and
controlling the camera module to shoot a target photo based on a focus parameter of the focus process upon the completion of the countdown if no user operation command is received during the countdown.

2. The focusing method for photography as claimed in claim 1, further comprising:
terminating the countdown if the user operation command is received via the touch screen during the countdown.

3. The focusing method for photography as claimed in claim 2, wherein the user operation command is another focus command performed on the camera preview screen, and the method further comprising:
initiating a next countdown according to the delay time if the another focus command is received during the countdown.

4. The focusing method for photography as claimed in claim 1, further comprising:
controlling the camera module to capture a reference image before the completion of the countdown;
wherein the step of controlling the camera module to shoot the target photo based on the focus parameter of the focus process upon the completion of the countdown if no user operation command is received during the countdown comprises:
upon the completion of the countdown, controlling the camera module to capture a target image based on the focus parameter of the focus process; and
storing the target image as the target photo when a similarity between the reference image and the target image meets a similarity condition.

5. The focusing method for photography as claimed in claim 4, wherein the reference image is captured in response to the completion of the focus process.

6. The focusing method for photography as claimed in claim 4, further comprising:
discarding the target image without storing the target photo when the similarity between the reference image and the target image does not meet the similarity condition.

7. The focusing method for photography as claimed in claim 1, wherein the step of executing the focus process according to the focus command and initiating the countdown according to the delay time comprises:
determining a focus area according to a touch position of the focus command in the camera preview screen; and
executing the focus process according to the focus area.

8. The focusing method for photography as claimed in claim 7, wherein the step of executing the focus process according to the focus command and initiating the countdown according to the delay time further comprises:
initiating the countdown according to the delay time when the focus process is completed.

9. The focusing method for photography as claimed in claim 1, further comprising:
setting the delay time according to a user setting command.

10. An electronic device, comprising:
a camera module, comprising a lens and an image sensor;
a touch screen; and
a processor, coupled to the camera module and the touch screen, and configured to:
receive a focus command performed on a camera preview screen via the touch screen;
execute a focus process according to the focus command and initiating a countdown according to a delay time;
determine whether a user operation command is received via the touch screen during the countdown; and
controlling the camera module to shoot a target photo based on a focus parameter of the focus process upon the completion of the countdown if no user operation command is received during the countdown.
